(19) United States
(12) Patent Application Publication
(10) Pub. No.: US 2003/0097576 A1
(43) Pub. Date: May 22, 2003

(54) Apparatus and method for operating a cryptographic vault device with electronic devices

(76) Inventors: Rana Dutta, Shelton, CT (US); Richard H. Rosen, Trumbull, CT (US); Robert F. Labbancz, New Canaan, CT (US); James M. Mattern, Bethany, CT (US)

Correspondence Address: PERMAN & GREEN, 425 POST ROAD, FAIRFIELD, CT, 06824, US

(21) Appl. No.: 10/281,721

(22) Filed: Oct. 28, 2002

Related U.S. Application Data
(60) Provisional application No. 60/346,185, filed on Oct. 26, 2001.
(60) Provisional application No. 60/412,894, filed on Sep. 23, 2002.

(51) Int. Cl. G06F 12/14

(52) U.S. Cl. 713/189

(57) ABSTRACT

A system for operating at least one secure cryptographic vault device. In one embodiment, the system comprises a vault manager for communicating with the secure cryptographic vault device. The vault manager is adapted to be implemented on a computerized system and adapted to integrated with an application program for transmission of data from the application program to the secure cryptographic vault device and transmission of an indicia from the cryptographic vault device to the application program. The at least one secure cryptographic vault device receives data and generates the indicia based on the received data and additional data previously stored in the cryptographic vault device.

### CROSS-REFERENCE TO RELATED APPLICATIONS

This application claims the benefit of U.S. Provisional Application No. 60/346,185, filed Oct. 26, 2001, and 60/412,894, filed Sep. 23, 2002, the disclosures of which are incorporated by reference herein in their entirety.

### BACKGROUND OF THE INVENTION

1. Field of the Invention

The present invention relates to the secure storage of-data and, more particularly, to operating a secure cryptographic vault device with an electronic device.

2. Brief Description of Related Developments

A secure cryptographic vault device, also known as a postal security device (PSD), is used for securely storing data, such as amounts of postage. The cryptographic vault device can securely store data so that the data cannot be tampered with without destroying the data. The data stored in a cryptographic vault is secured against physical attacks on the hardware of the cryptographic vault device and against software intrusions.

The cryptographic vault device is integrated in turnkey postage dispensing systems, such as postage meters. Other devices integrated with the cryptographic vault device can include, for example, a printer, a scale, and an envelope feeder mechanism. The turnkey system can also include a personal computer, server or workstation directly coupled to the cryptographic vault device. Direct access to the cryptographic vault device is only from some of the integrated components of the postage dispensing system. Therefore, the use of the cryptographic vault device is limited to the functions built into the integrated postage dispensing system. In order to provide customized access to the cryptographic vault device, a user would have to acquire a turnkey system, which includes predefined devices and software, and then customize the turnkey system to meet business requirements.

### SUMMARY OF THE INVENTION

The present invention is directed to a system for operating at least one secure cryptographic vault device. In one embodiment, the system comprises a vault manager for communicating with the secure cryptographic vault device. The vault manager is adapted to be implemented on a computerized system. The vault manager is also adapted to interface with an application program for transmission of data from the application program to the secure cryptographic vault device, and transmission of an indicia from the cryptographic vault device to the application program. The at least one secure cryptographic vault device receives data and generates the indicia based on the received data and additional data previously stored in the cryptographic vault device.

The present invention includes a method for operating at least one secure cryptographic vault device. In one embodiment, the method comprises communicating data for generating an indicia from an application program to a vault manager for accessing the cryptographic vault device. The transferred data is communicated from the vault manager to the cryptographic vault device, and the indicia is generated in the cryptographic vault device based on the transferred data and additional data previously stored in the cryptographic vault device. The indicia is communicated to the vault manager, and transferred from the vault manager to the application program.

The present invention also includes a system for interfacing with a cryptographic vault device. In one embodiment, the system comprises a computerized system for establishing communications with the cryptographic vault device, and an application program implemented on the computerized system for indirectly transferring data to and receiving indicia from the cryptographic vault device. A vault manager is integrated with the application program for providing the only direct communication to the cryptographic vault device, wherein the cryptographic vault device generates the indicia based on the transferred data and other data previously stored in the cryptographic vault device.

### BRIEF DESCRIPTION OF THE DRAWINGS

The foregoing aspects and other features of the present invention are explained in the following description, taken in connection with the accompanying drawings, wherein:

FIG. 1 is a block diagram of one embodiment of a system incorporating features of the present invention for operating a cryptographic vault device.

FIG. 2 is a block diagram of an embodiment of a system incorporating features of the present invention including a plurality of cryptographic vault devices.

FIG. 3 is a block diagram of an embodiment of a system incorporating features of the present invention illustrating a cryptographic vault device incorporated with other devices.

FIG. 4 is a schematic diagram of an embodiment of a client/server system incorporating features of the present invention for accessing a cryptographic vault device.

FIG. 5 is a schematic diagram of an embodiment of a client/server system incorporating features of the present invention including multiple cryptographic vault devices.

FIG. 6 is an illustration of a method for employing an embodiment of the present invention.

FIG. 7 is a block diagram of a system incorporating features of the present invention illustrating the use of pooled PSD's.

FIG. 8 is a schematic illustration of one embodiment of a system incorporating features of the present invention.

FIG. 9 is a block diagram of one embodiment of a system incorporating features of the present invention.

FIG. 10 is a block diagram of one embodiment of a system incorporating features of the present invention.

### DETAILED DESCRIPTION OF THE PREFERRED EMBODIMENT(s)

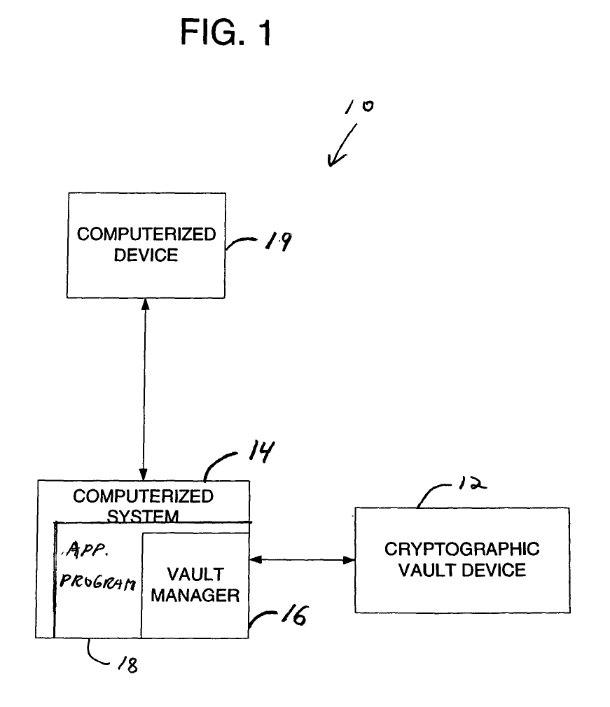

Referring to FIG. 1, a diagrammatic view of a system 10 incorporating features of the present invention is illustrated. Although the present invention will be described with reference to the embodiment shown in the drawings, it should be understood that the present invention can be embodied in many alternate forms of embodiments. In addition, any suitable size, shape or type of elements or materials could be used.

As shown in FIG. 1, the system 10 generally comprises a standalone cryptographic vault device 12 for the secure storage of data a computerized system 14 and a computerized device 19. In alternate embodiments the system 10 can include such other suitable components for incorporating information based indicia (“IBI”) technology earlier in the mail preparation process. It is a feature of the present invention to enable higher volume mailing processes to benefit from IBI proof of payment by enhancing postal security and revenue protection and provide the benefits of permit mail and metered. In one embodiment, the cryptographic vault device 12 can be about the size of a pack of playing cards and can be equipped with an electronic interface, such as a socket (not shown). In one embodiment, the cryptographic vault device 12 comprises a Secure Authenticating Funds Engine™ (SAFE™) crypto-vault manufactured by Hasler (Neopost). For further information on cryptographic vault devices 12, such as postal security devices, please see U.S. Pat. Nos. 6,009,417, 6,041,317 and 6,227,445, which are hereby incorporated herein by reference. The cryptographic vault device 12 is connected to the computerized system 14, such as a computer on which a vault manager module 16 can be implemented.

The connection between the cryptographic vault device 12 and the computerized system 14 can comprise a hard-wire connection, but, in alternate embodiments can include wireless or optical transmission means. The vault manager module 16 is generally stored or located on the computerized system 14. The cryptographic vault device 12 is adapted to be accessed through the vault manager module 16. The vault manager module 16 is adapted to handle all low level communication with the cryptographic vault device 12 and provides high level functions, such as printing postage, loading money into the cryptographic device 12, and examining logs on the cryptographic device 12. The computerized system 14 can be connected to a computerized device 19 for transmitting data to the computerized system 14, and receiving indicia from the computerized system 14. In one embodiment the vault manager module is implemented as a software development kit that provides a high level API to the application developer that implements the low level communication to the SAFE™ 12 and the infrastructure. The SDK or vault manager 16 will generally sit between the information based indicia solution, such as the CVD 12 and a third party application, such as the device 19. Security is maintained by providing only high level access to the CVD 12.

The computerized system 14 can include an application program 18, such as a host application 18, for transmitting data to the cryptographic vault device 12. The vault manager module 16 is integrated with the application program or application program module 18. The application program module 18, which can also be referred to as an application program interface, can also be adapted to provide configuration settings, enabling/disabling features, informational data and replenishment of the cryptographic vault device 12. The application program module 18 can also be adapted to provide indicia creation, such as for example, postage. In another embodiment, the vault manager module 16 can be a separate module from the application program 18 invoked by the application program 18.

Continuing with FIG. 1, the vault manager module 16 can transmit data, such as for example an address and a requested amount of postage, from the application program 18 to the cryptographic vault device 12. The cryptographic vault device 12 can generate an indicia, such as a verifyable indicia indicating a proof of postage indicia. The indicia can be in machine readable format, such as a bar code. The indicia can be returned in a number of different image formats, such as a bitmap or Portable Document Format (PDF). The indicia generally includes a digital signature for validating the indicia. While the generation of an indicia has been shown, the proof of postage can also be generated by the cryptographic vault device 12 and returned to the vault manager module 16 as a byte string instead of as an image, without departing from the broader aspects of the present invention. Although as described in this embodiment, the cryptographic vault device 12 can be used for storing and dispensing amounts of postage downloaded from a postal service, in alternate embodiments the cryptographic vault device can be used for any other use which would benefit from secure data storage.

Referring to FIG. 1, the vault manager module 16 can transmit an indicia image or a byte string representing the indicia to the application program 18. The application program 18 can indicate that it prefers to receive a byte string instead of an indicia image when the indicia is to be used in high speed printing. For some types of printing devices, formatting and printing the byte string can be faster than printing the indicia image.

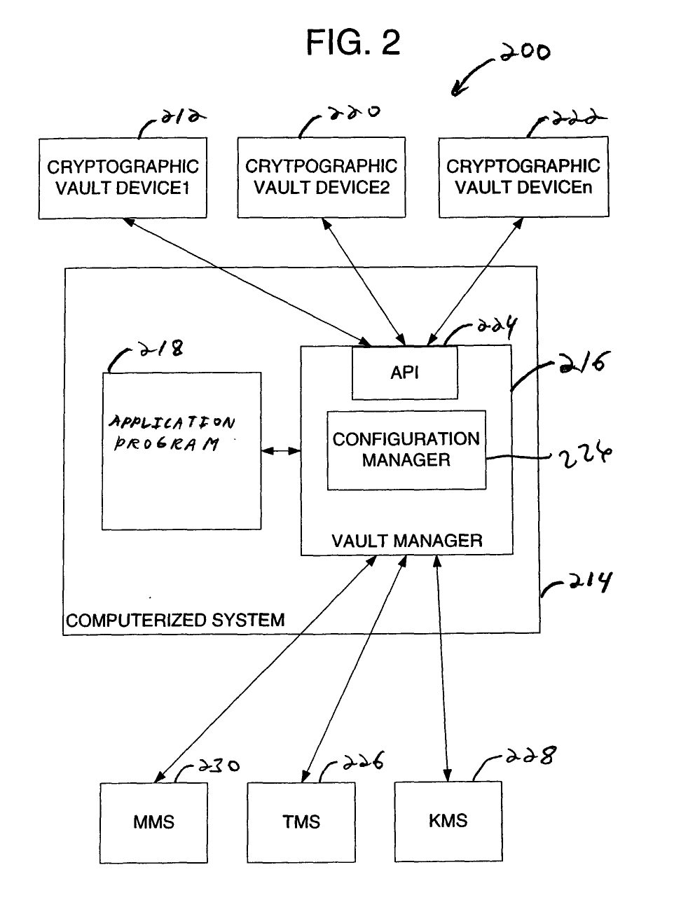

Referring to FIG. 2, in one embodiment, a system 200 can include multiple cryptographic vault devices 212, 220, 222 in communication with a vault manager 216. The vault manager 216 can communicate with and coordinate the employment of the multiple cryptographic vault devices 212, 220, 222. For instance, the cryptographic vault devices 212, 220, 222 can be divided into groups according to function. The group functions could include a group of vault devices 222 ready to be assigned for processing, such as creating indicia which dispense postage amounts from postage funds stored in the vault devices 222.

Continuing with FIG. 2, a second group of vault devices 220 can be engaged in processing, such as dispensing the postage funds in the vault devices 220, and a third group of vault devices 212 can be depleted of postage funds and can be in the process of being replenished with funds.

If one of the cryptographic vault devices 212 in the processing group no longer contains sufficient postage to continue processing, the vault manager module 216 can remove the vault device 220 from the processing group and place the vault device 220 in the replenish group. After the vault device 220 has been replenished, for example, with an additional amount of postage, the vault device 220 can be transferred back to the group of vault devices engaged in processing. This redundancy allows any one of the vault devices 220 to be able to take over the functionality of another vault device 220. This redundancy can be useful in situations where a vault device or PSD is out of funds, or a vault device fails for any reason.

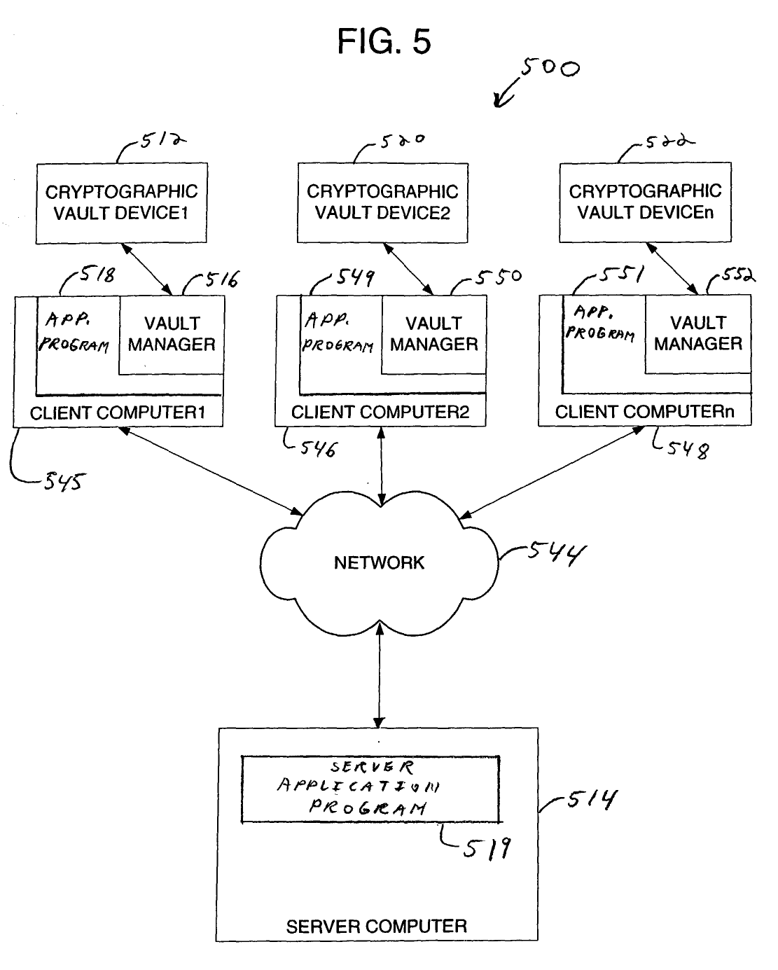

The cryptographic vault devices 212, 220, 222 may also be grouped by pairs of vault devices. The vault manager module 216 will coordinate the generation of indicia by controlling multiple pairs of vault devices 212, 220, 222. One of the pair of cryptographic vault devices 212, 220, 222 will always available for the creation of postage indicia, even if the other vault device 212, 220, 222 is out of funds and being replenished. Although the terms “paired” is used herein, any number of vault devices can be grouped. This may also be referred to as “pools”. Each group or pool can allow for redundancy of operations in the event of a replenishment need or a device failure and allows for pooled “SAFE™” redundancy. Faster throughput for the generation of postage indicia is secured by using multiple pairs of vault devices 212, 220, 222. Additional throughput can be realized by adding multiple clients (See FIG. 5). The configuration of vault devices 212, 220, 222 and the vault manager 216 permit the development of software or software development kits (“SDK”) which allows the vault devices 212, 220, 222 to be added or removed on the fly, thus allowing for true enterprise mailroom scalability.

The cryptographic vault devices 212, 220, 222 can also be stored on site or off site in for example a locked-room or other secure storage area. One or more firewalls can be used to secure the cryptographic vault devices 212, 220, 222. The configuration of stand-alone cryptographic vault devices 212, 220, 222 and vault manager 216 also permit remote or offsite administration of the vault devices, and permit multiple computer configurations, as shown in other embodiments to be described later.

As shown in FIG. 2, an application program 218, such as a host application, can be implemented on a computerized system 214 along with the vault manager module 216. The vault manager 216 can be combined with other applications, such as the application program 218, generated by third parties or developed internally to print postage locally or remotely. The application program 218 can provide data to the vault manager module 216, which uses an application program interface (API) 224 for communicating the data to the cryptographic vault devices 212, 220, 222.

The indicia, which can represent a proof of postage, can be generated by the cryptographic vault device 212, 220, 222 based on the data from the application program 218 and data stored in the cryptographic vault device 212, 220, 222. The data stored in the cryptographic vault device 212, 220, 222 can include an amount of postage and any other data which can benefit from protected storage.

The cryptographic vault device can also include predefined data, such as vault device identification data, including a vault device serial number. The inclusion of vault device identification data in the generated indicia allows tracking of the indicia back to a particular vault device. The proof of postage from the cryptographic vault device 212, 220, 222 can be communicated to the vault manager 216 through the API 224, and transferred to the application program 218.

Continuing with FIG. 2, the vault manager module 216 can also include a configuration manager 226, which can define and store preferred settings for the application program 218. The preferred settings can include the format in which the indicia will be generated and returned to the vault manager module 216, such as an indicia image or a byte string. The preferred settings can also include communication settings for communications between the computerized system 214 and the cryptographic vault devices 212, 220, 222, such as selecting a communication protocol and communication speed. Other preferred settings can include upper and lower limits on the amount of postage to be stored in a cryptographic vault device 212, 220, 222.

Referring to FIG. 2, funds, such as a postage amount, can be downloaded to the cryptographic vault device 212 with a telemeter setting remote system (TMS) 226. TMS is a remote system which can provide new or additional funds from a postal carrier to a cryptographic vault device 212. In one embodiment, the present invention provides for the simultaneous downloading of funds to multiple cryptographic vault devices. In the present invention, the connection between the telemeter setting remote system 226 and each cryptographic vault device 212 is shared between all the devices 212. This allows for funds to be transmitted to all of the devices simultaneously. It is a feature of the present invention to refill or replenish all of the devices 212 at once unlike other systems where a connection is made and each device takes its turn to download the replenishment amount. TMS 226 can automatically be invoked by the vault manager module 216 when the amount of postage in a cryptographic vault device 212, 220, 222 is below the lower limit set by the vault manager module 216. TMS 226 accesses the cryptographic vault device 212, 220, 222 through the vault manager 216 in order to download the funds. Similarly, a key management system (KMS) 228 is a remote system which is responsible for key exchange with the cryptographic vault devices 212, 220, 222 for generation of indicia. An optional mail room management system (MMS) 230 can collect detailed postal statistics, and can report on accounting information kept by the cryptographic vault devices 212, 220, 222. MMS 230 can provide for export of the accounting information. Access to and from the cryptographic vault devices 212, 220, 222 by the KMS 228 and the MMS 230 is only via the vault manager module 216.

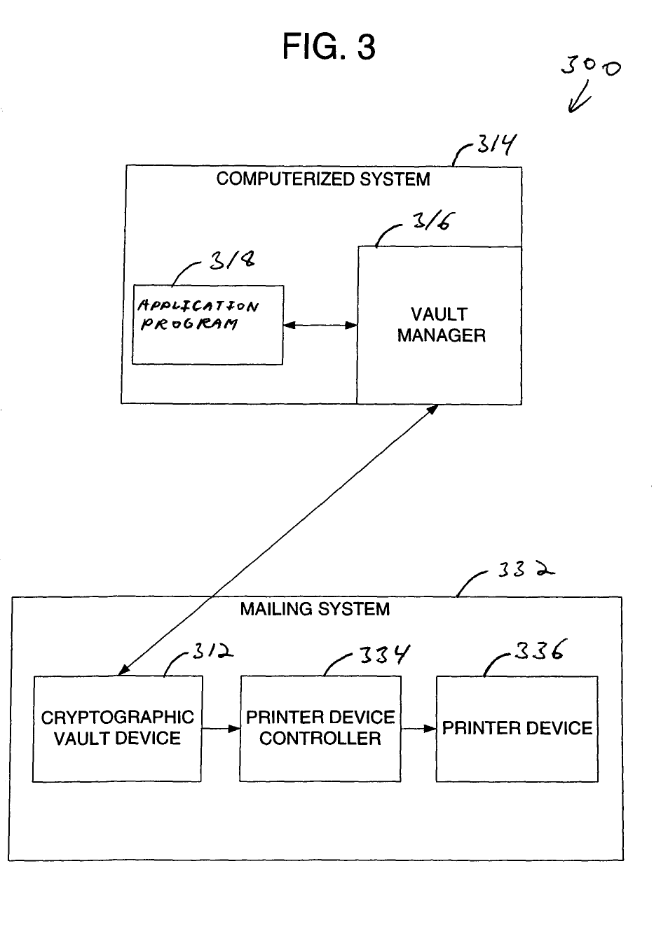

Referring to FIG. 3, in another embodiment, a system 300 includes an application program 318, such as a host application, implemented on a computerized system 314 along with a vault manager module 316. The vault manager is the only means of communication with cryptographic vault device 312. The cryptographic vault device 312 is integrated into a dedicated mailing system 332 having a dedicated printer device controller 334 and a printer device 336.

Continuing with FIG. 3, the vault manager module 316 can communicate data to the cryptographic vault device 312 for generating a proof of postage, such as an indicia. The generated indicia can be printed by the printer device 336 under control of the dedicated printer device controller 334. The proof of postage imprint can be digitally signed and printed in machine-readable format, such as a bar code. The proof of postage can be used in both metering and permit methods of payment of postage. In another embodiment, the dedicated mailing system 332 can be linked through the vault manager 316 with a TMS system and a KMS system, as well as linked through the vault manager 316 to a MMS system for collection of detailed postal statistics.

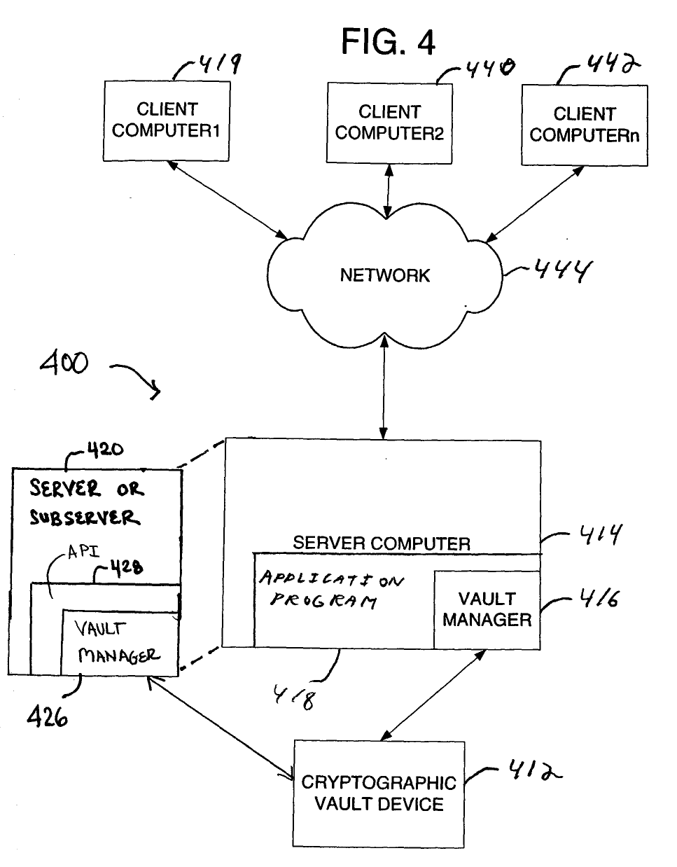

As shown in FIG. 4, the present invention can be implemented in a client/server system 400. The client/server system 400 can include more than one computerized device 419, 440, 442, such as client computers 419, 440, 442. The client computers 419, 440, 442 can communicate with a vault manager module 416 via a network 444, such as the Internet. Other networks can be used for communication with a cryptographic vault device 412 without departing from the broader aspects of the present invention. The vault manager module 416 allows the cryptographic vault device 412 to be used with any carrier, such as a telephone or cable system, or any type of service provider, such as an internet service provider (ISP).

The vault manager module 416 can be implemented on a computerized system 414, such as a server computer 414. The vault manager module can be integrated with an application program 418 which is also implemented on the computerized system 414. The vault manager module 416 provides the only access to the cryptographic vault device 412. While one cryptographic vault device 412 in communication with the vault manager module 416 has been shown, the present invention is not so limited, as more than one cryptographic vault device 412 can be linked without departing from the broader aspects of the present invention.

The vault manager module 416 provides independent software vendors an ability to combine specific software components with the vault manager module 416 to create private labeling. The private label software can be installed on client/workstation computers 419, 440, 442 for printing or generation of indicia remotely. Additionally, the software components, such as the application program 418 and the vault manager module 416, can produce the indicia on the server computer 414 without having the software for generating indicia installed on the client computers 419, 440, 442. The indicia image or byte string representing the indicia can be returned through web based transport technologies 444 to the client computer 419, 440, 442 to be printed. Other types of transport technologies, such as other internet based networks and wide area networks, can also be employed for transporting the indicia image or byte string. In another embodiment, instead of being printed, the indicia can be transmitted to private or custom software which can be located on the server computer 414 or on the client computers 419, 440, 442 for any other use.

Continuing with FIG. 4, the functions related to the cryptographic vault device 412 can be defined or restricted for each of the client computers 419, 440, 442. For instance, one client computer 418 can initiate a download of postage to the cryptographic vault device 412, while another client computer 440 will not be able to initiate a download of postage. The definition of allowed functions for the each of the client computers 419, 440, 442 can be based on the client computer's location. For example, a client computer 419, 440, 442 located in a semi-public location, such as a mailroom, should not be able to initiate a download of postage. In alternate embodiments, a third party or private label system may expose certain functionalities of the system using a user-defined application programmer interface. A client computer's functions may also be defined by the job obligations of the client computer's user. FIG. 4 also illustrates the situation where multiple vault managers manage a single cryptographic vault device. The device 420 could be on the same device 418 as the server computer, or could be another, separate server. The vault manager 426 is coupled to the vault device 412, and includes its own application program interface 428.

Referring to FIG. 5, in another embodiment of a system 500 of the present invention, each client computer 545, 546, 548 can be in communication with its own cryptographic vault device 512, 520, 522. Each client computer 545, 546, 548 can include a vault manager module 516, 550, 552 integrated with a respective application program 518, 549, 551 to communicate with its cryptographic vault device 512, 520, 522. This configuration provides enhanced performance and reduces utilization of a server computer 514 associated with each client computer 545, 546, 548. Each client computer 545, 546, 548 can communicate via a network 544, such as the internet, with the server computer 514. The server computer 514, and a server application program 519 implemented on the server computer 514, can provide data to and receive a proof of postage, such as an indicia, from a particular cryptographic vault device 512 through the corresponding client computer 545, application program 518 and vault module 516.

Continuing with FIG. 5, the server application program 519 can also coordinate the functions of the cryptographic vault devices 512, 520, 522. The server application program 519 can assume a supervisory role and manage maintenance, funds management, auditing and configuration. The client role 545, 546, 548 can be specific to indicia generation and can use software code optimized for the indicia generation. The access to the cryptographic vault device 512, 520, 522 is provided by the corresponding vault manager module 516, 550, 552.

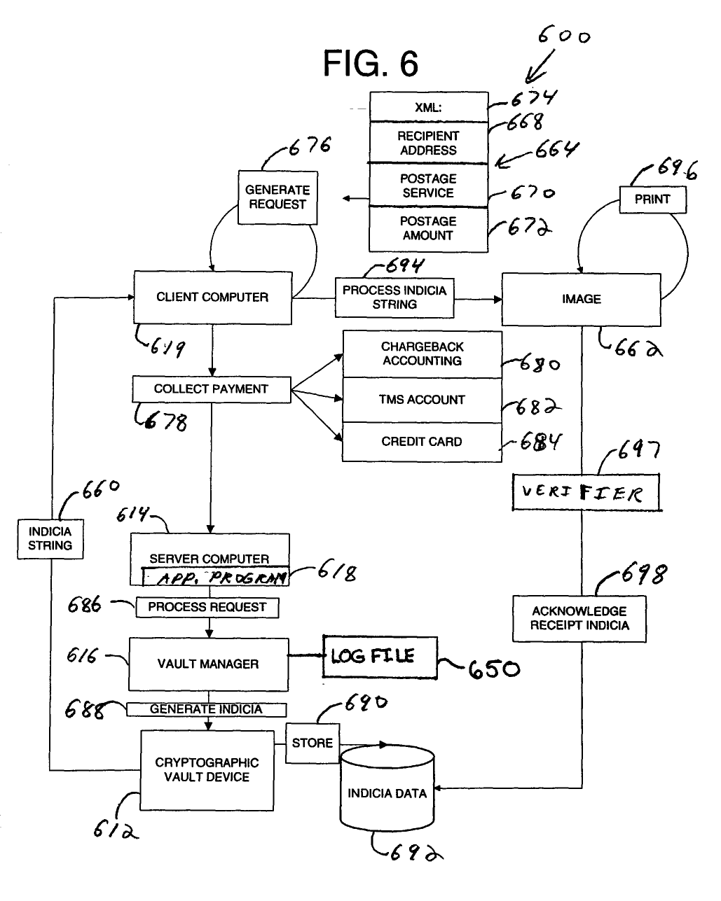

FIG. 6 shows a method 600 for operating a cryptographic vault device 612 for generating an indicia string 660, and producing an indicia image 662 from the indicia string 660. A client computer 619 can generate 676 request data 664 such as a recipient address 668, a postage service 670 and a postage amount 672. The request data 664 can be formulated in extended markup language (XML) format 674, although any format for encoding and transferring the request data 664 can be used. Before the indicia string 660 is generated, the client computer 619 can collect payment 678 for the requested postage amount 672 and other services by a number of methods. Methods of payment can include chargeback accounting 680, charging a TMS account 682, or charging a credit card 684. The client computer 618 can transfer the request data 664 for the indicia string 660 to a server computer 614 over a network (not shown). Referring to FIG. 6, the server computer 614 processes 686 the request data 664 and passes the request data 664 to a vault manager module 616 that is preferably implemented with an application program 618 on the server computer 614. The vault manager module 616 transfers the request data 664 to a cryptographic vault device 612, which generates 688 the indicia string 660. The indicia string 660 is stored 690 in a database 692 for future use, and transferred to the client computer 619. The client computer 619 can process 694 the indicia string 660 and can generate an indicia image 662 from the indicia string 660 which is printed 696 via a printer. A mailing printer can include thermal printing, ink jet printing, or other technology.

Continuing with FIG. 6, a verifier 697 can read the postal indicia image 662 to confirm that the image 662 has been correctly applied to a mailing piece and that the image 662 is readable by scanning equipment. In the event that either the indicia image 662 has been incorrectly applied by the mailing printer 696, or improperly printed, partially printed or missing, the verifier 697 will notify the mailing system control to either stop, divert the mail piece or notify an operator. An acknowledge receipt indicia 698 can be generated by the client computer 619 and stored in the database 692 with the indicia string 660. The verifier 697 can also be used to detect counterfit indicia.

The system illustrated in FIG. 6 can also include a log file 650 adapted to perform error tracking and debugging functionality, and provide evidence of recorded changes.

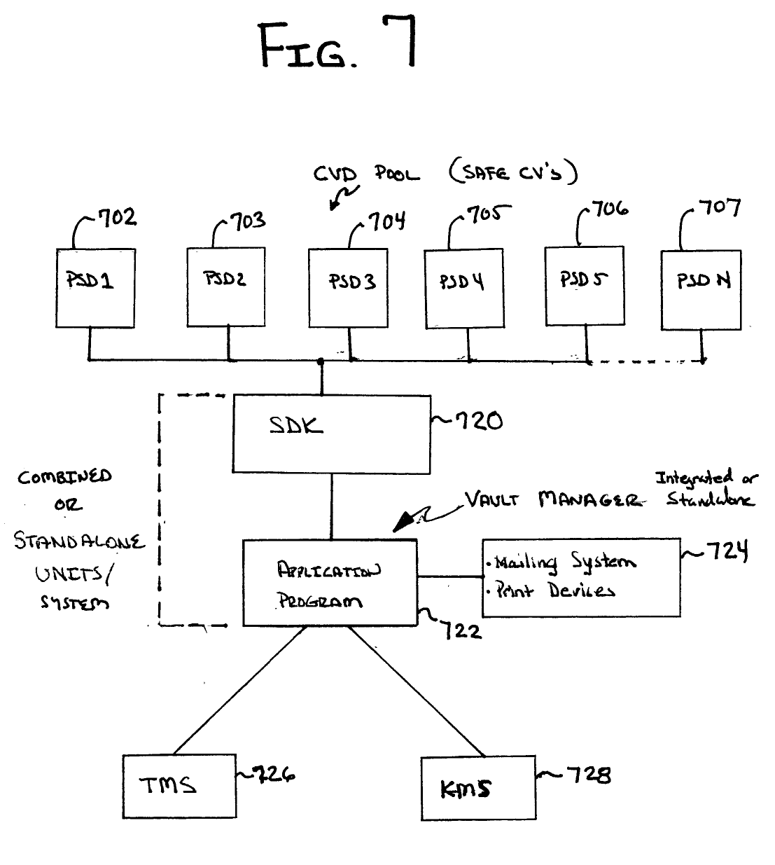

FIG. 7 illustrates one embodiment of a system 700 incorporating features using a pool of PSD's (702-707). Each PSD is combined with a dedicated printer controller and printing device to produce indicia, using software SDK 720 for proof of postage. The combined result is mailing system to print proof of postage. The proof of postage imprint will be digitally signed and printed in machine-readable format. This may be used in both the metering and permit methods of payment of postage and can be tied to the TMS 726 and KMS 728 system, as well as its Mailroom Management System for the collection of detailed postal statistics. The SDK 720 may be combined with other party or internally developed applications to print postage locally or remotely. The SDK works with one or more PSD (702-707) for the creation of postal indicia. The SDK will coordinate the securing of the indicia information by controlling the pools of PSDs (702-707). PSD pools provide a backup PSD so that when one PSD is depleted of funds another PSD within the pool takes over while the first gets reloaded with money. Faster throughput is secured by configuring more PSD from the PSD pool. Additional throughput can be realized by adding multiple clients, as the SDK 720 is capable of providing Indicia faster than they can be printed. Another increase in throughput can also be realized by increasing the host computer processors; additional processors allow the SDK's host computer to manage a greater number of PSD. The SDK 720 will serve as the coordinator between the application program 722, the PSDs 702-707, and the TMS 726 and KMS 728 systems.

The present invention allows the integration of information based indicia with source applications. This can enhance customer value by incorporating IBI technology earlier in the mail preparation process and eliminates unnecessary steps. Higher volume mailing processes will benefit from IBI proof of payment by enhancing postal security and revenue protection and providing the benefits of permit mail and metered mail.

The present invention may also include software and computer programs incorporating the process steps and instructions described above that are executed in different computers. In the preferred embodiment, the computers are connected to the Internet. FIG. 4 is a block diagram of one embodiment of a typical apparatus incorporating features of the present invention that may be used to practice the present invention. As shown, a computer system 414 may be linked to another computer system 419, and/or 440 or 442, such that the computers 414 and 419 are capable of sending information to each other and receiving information from each other. In one embodiment, computer system 414 could include a server computer adapted to communicate with a network 444, such as for example, the Internet. Computer systems 414 and 419 can be linked together in any conventional manner including a modem, hard wire connection, or fiber optic link. Generally, information can be made available to both computer systems 414 and 419 using a communication protocol typically sent over a communication channel or through a dial-up connection on ISDN line. Computers 414 and 419 are generally adapted to utilize program storage devices embodying machine readable program source code which is adapted to cause the computers 414 and 419 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 414 and 419 may also include a microprocessor for executing stored programs. Computer 414 may include a data storage device 56 on its program storage device for the storage of information and data. The computer program or software incorporating the processes and method steps incorporating features of the present invention may be stored in one or more computers 414 and 419 on an otherwise conventional program storage device. In one embodiment, computers 414 and 419 may include a user interface and a display interface from which features of the present invention can be accessed. The user interface and the display interface can be adapted to allow the input of queries and commands to the system, as well as present the results of the commands and queries.

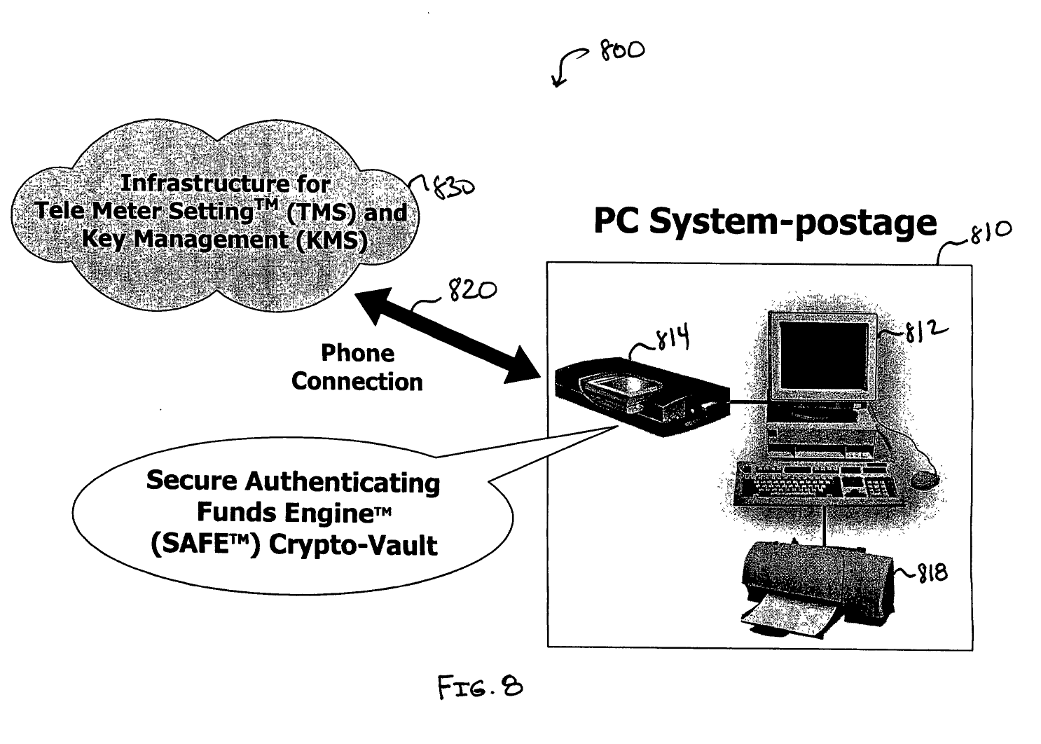

Referring to FIG. 8, one embodiment of an implementation of a system incorporating features of the present invention is illustrated. As shown in FIG. 8, the system 800 comprises a PC based postage system 810, a crypto-vault 814 and a telemeter setting and key management system 830. Although a PC based postage system is illustrated, any suitable system for generating a verifyable indicia can be used as the present invention is not limited to postage system. The crypto-vault 814 can be an integral part of the PC 812 or a stand alone device. The PC system 810 and infrastructure 830 are coupled by any suitable means including a hard-wire connection, a phone/modem connection or a wireless connection.

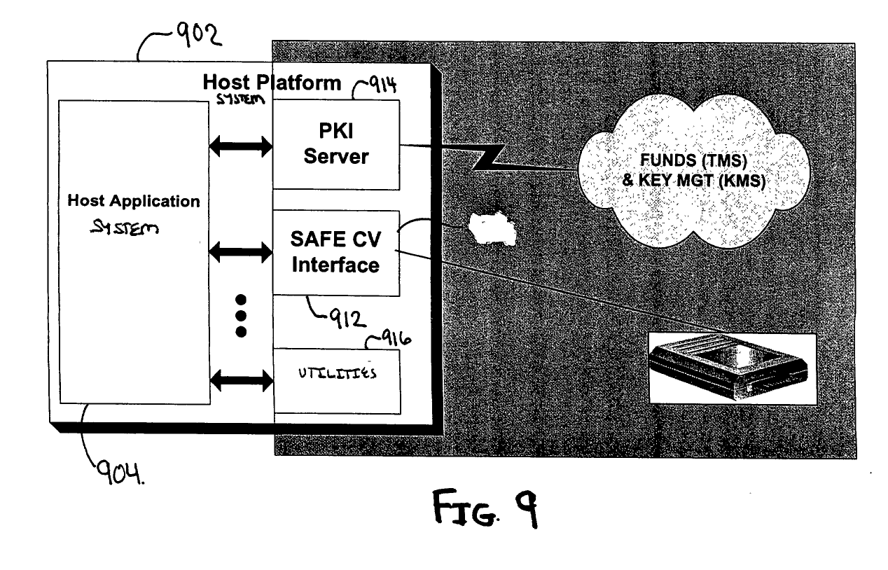

Another embodiment of the present invention is illustrated in FIG. 9. As shown in FIG. 9, the cryptographic vault 912 is embedded into a host platform 902 as is the PKI server 914, which can include funds (TMS) and key management (KMS). The host platform can include for example, a specialized printer, an inserter, a kiosk, or a third party software application. For example, in one embodiment, the host application device 904 could comprise a direct mail application system using a high speed inserter with a bar code reader. The host application system 904 could also be connected to other suitable utilities 916.

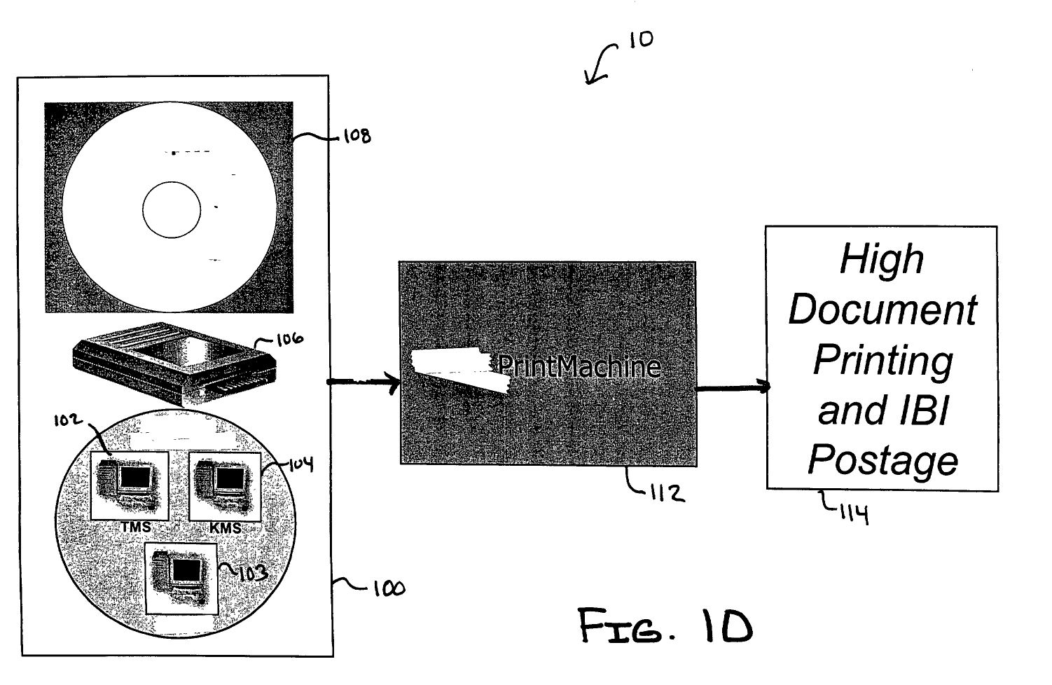

Another embodiment of a system 100 incorporating features of the present invention is illustrated in FIG. 10. The host platform system 100 includes the funds (TMS) 102 and key management (KMS) systems, the cryptovault system 106 and the configuration manager system 108. The host platform system 100 can also include a database system 103. The host system 100 is coupled to a printing system 112, which is adapted for high speed document printing. The documents 117 are produced at a high rate with the information based indicia thereon.

The present invention is generally adapted to allow the use of cryptographoc device or devices into a user based system. The present invention allows for the incorporation of the cryptographic vault device into a system in order to print documents with complete proof of postage paid and information based indicia. The system can produce documents or mailpieces at high speeds and can operate with any number of printers or other printing devices. The system can also use multiple cryptographic vault devices, or SAFE(s)™.

The present invention can eliminate the need for additional hardware to print postage, eliminate the need for additional operations, provides unique identification for each mailpiece, simplifies the postal process and mail preparation, provides detailed reporting about mailing and can be implemented as part of an integrated postal solution for mail “factories”.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A system for operating at least one secure cryptographic vault device, comprising:
a vault manager for communicating with the secure cryptographic vault device, the vault manager adapted to be implemented on a computerized system and adapted to integrated with an application program for transmission of data from the application program to the secure cryptographic vault device and transmission of an indicia from the cryptographic vault device to the application program; and
wherein the at least one secure cryptographic vault device receives data and generates the indicia based on the received data and additional data previously stored in the cryptographic vault device.

2. The system of claim 1, further comprising:
a printing device controller in communication with the cryptographic vault device for receiving the indicia from the cryptographic vault device; and
a printing device in communication with the printing device controller for printing the indicia.

3. The system of claim 1, wherein the vault manager includes an application program interface (API) for communicating with the cryptographic vault device.

4. The system of claim 1, wherein if the cryptographic vault device is no longer available for processing, the vault manager automatically selects another cryptographic vault device for processing.

5. The system of claim 1, wherein the application program is in communication with more than one cryptographic device through the vault manager.

6. The system of claim 1, wherein each of the more than one cryptographic vault device is categorized according to current usage for efficient utilization of each of the more than one cryptographic vault device.

7. The system of claim 1, wherein the cryptographic vault device is accessible though the vault manager from more than one computerized device.

8. The system of claim 1, wherein the cryptographic vault device is remotely located from the computerized system for providing security for the cryptographic vault device.

9. The system of claim 1, further comprising:
a tele-metering system (TMS) in communication with the vault manager for downloading an amount of postage to the cryptographic vault device; and
a key management system (KMS) in communication with the vault manager for managing digital key exchange with the cryptographic vault device.

10. The system of claim 1, further comprising a verifier device for reading the indicia to confirm that the indicia is correctly displayed.

11. The system of claim 1, wherein the vault manager is implemented on a server computer, and the computerized device is a client computer in communication with the vault manager over a network.

12. A method for operating at least one secure cryptographic vault device, comprising the steps of:
communicating data for generating an indicia from an application program to a vault manager for accessing the cryptographic vault device;
communicating the transferred data from the vault manager to the cryptographic vault device;
generating the indicia in the cryptographic vault device based on the transferred data and other data previously stored in the cryptographic vault device;
communicating the indicia to the vault manager; and
transferring the indicia from the vault manager to the application program.

13. The method of claim 12, where in the step of communicating the transferred data from the vault manager to the cryptographic vault device, the application program communicates with more than one cryptographic device through the vault manager.

14. The method of claim 12, where in the step of communicating the transferred data from the vault manager to the cryptographic vault device, the cryptographic vault device is remotely located from the computerized device for providing security for the cryptographic vault device.

15. The method of claim 12, further comprising the steps of:
displaying the indicia received from the vault manager; and
reading the indicia with a verifier device to confirm that the indicia is correctly displayed.

16. The method of claim 12, where in the step of communicating data for generating an indicia from a computerized device to a vault manager, the vault manager is implemented on a server computer, and the computerized device is a client computer in communication with the vault manager over a network.

17. The method of claim 12, where in the step of generating the indicia in the cryptographic vault device based on the transferred data and other data, the other data is data representing a postage fund.

18. The method of claim 12, where in the step of generating the indicia in the cryptographic vault device based on the transferred data and other data, the other data is data representing a serial number of the cryptographic vault device.

19. A system for interfacing with a cryptographic vault device, comprising:
a computerized system for establishing communications with the cryptographic vault device;
an application program implemented on the computerized system for indirectly transferring data to and receiving indicia from the cryptographic vault device; and
a vault manager integrated with the application program for providing the only direct communication to the cryptographic vault device, wherein the cryptographic vault device generates the indicia based on the transferred data and other data previously stored in the cryptographic vault device.

20. A method of integrating a source application with information based indicia comprising:
providing a postal security device pool combining at least one postal security device from the pool with a printer controller and a printing device of an application program device for printing of proof of postage; and
switching from the at least one postal security device to another postal security device when the at least one postal security device is depleted of funds.

21. A system for printing proof of postage comprising:
a pool of postal security devices;
an application program device adapted to communicate with each postal security device in the pool;
a indicia printing system adapted to insert the proof of postage on a mailpiece; and
wherein the application program device is adapted to switch to another postal security device in the pool when a currently used postal security device is depleted of funds.
